(19) United States
(12) Patent Application Publication
(10) Pub. No.: US 2015/0070649 A1
(43) Pub. Date: Mar. 12, 2015

(54) RANGE FINDER AND GLOBAL POSITIONING GLASSES

(71) Applicant: Garfield Mingo, East Orange, NJ (US)

(72) Inventor: Garfield Mingo, East Orange, NJ (US)

(21) Appl. No.: 14/482,707

(22) Filed: Sep. 10, 2014

Related U.S. Application Data
(60) Provisional application No. 61/877,079, filed on Sep. 12, 2013.

(51) Int. Cl. G01S 17/02; G02B 27/01; G01S 19/00; G02C 11/00

(52) U.S. Cl. CPC G01S 17/023; G02C 11/10; G02B 27/0176; G01S 19/00; G02B 2027/0178
USPC 351/158

(57) ABSTRACT

A pair of eyeglasses with a built in rangefinder is provided. The glasses project the distance to an object, such as a golf ball, onto the inner surface of the glasses. The device additionally includes a built in GPS for determining the location of a user on a golf course. The glasses notify a user as to the distance to a hole and provides users with a hands-free way to determine the distance from a golf ball to the green.

### CROSS-REFERENCE TO RELATED APPLICATION

This application claims the benefit of priority of U.S. provisional application No. 61/877,079, filed Sep. 12, 2013 the contents of which are herein incorporated by reference.

### BACKGROUND OF THE INVENTION

The present invention relates to a golf aid and, more particularly, to a range finder and global positioning glasses.

It can be difficult to determine the distance from a golf ball to the green. Unfortunately, without an accurate yardage reading, golfers may use the wrong clubs and drivers and overshoot or undershoot the hole. Not only does this negatively affect their score, but it also stretches out the length of the game. Some golfers may use handheld devices, but it can be a hassle to constantly retrieve these devices from a pocket or golf bag.

As can be seen, there is a need for an improved range finder and global positioning device for golfing.

### SUMMARY OF THE INVENTION

In one aspect of the present invention, a pair of glasses comprises: a glasses frame formed to secure to a user's head; at least one lens attached to the glasses frame, wherein the at least one lens comprises an inner surface and an outer surface; a lens display projected on the inner surface of the lens; a laser operatively connected to the lens display; a global positioning system operatively connected to the lens display, wherein data from the laser range and the global positioning system is displayed on the lens display.

These and other features, aspects and advantages of the present invention will become better understood with reference to the following drawings, description and claims.

### BRIEF DESCRIPTION OF THE DRAWINGS

FIG. 1 is a perspective view of the present invention shown in use;

FIG. 2 is a perspective view of the present invention;

FIG. 3 is a detailed view of FIG. 2;

FIG. 4 is a view looking through the glasses; and

FIG. 5 is a detailed view looking through the glasses.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a pair of glasses with a built-in rangefinder and global positioning system (GPS). The device determines the distance from a golf ball to the green while also protecting the eyes from the sun. Data appears on the lenses of the glasses, but users can still see beyond the glasses as well. The device has the capacity to calculate data based on where the user is standing. Further, the device eliminates the task associated with using a traditional handheld GPS device.

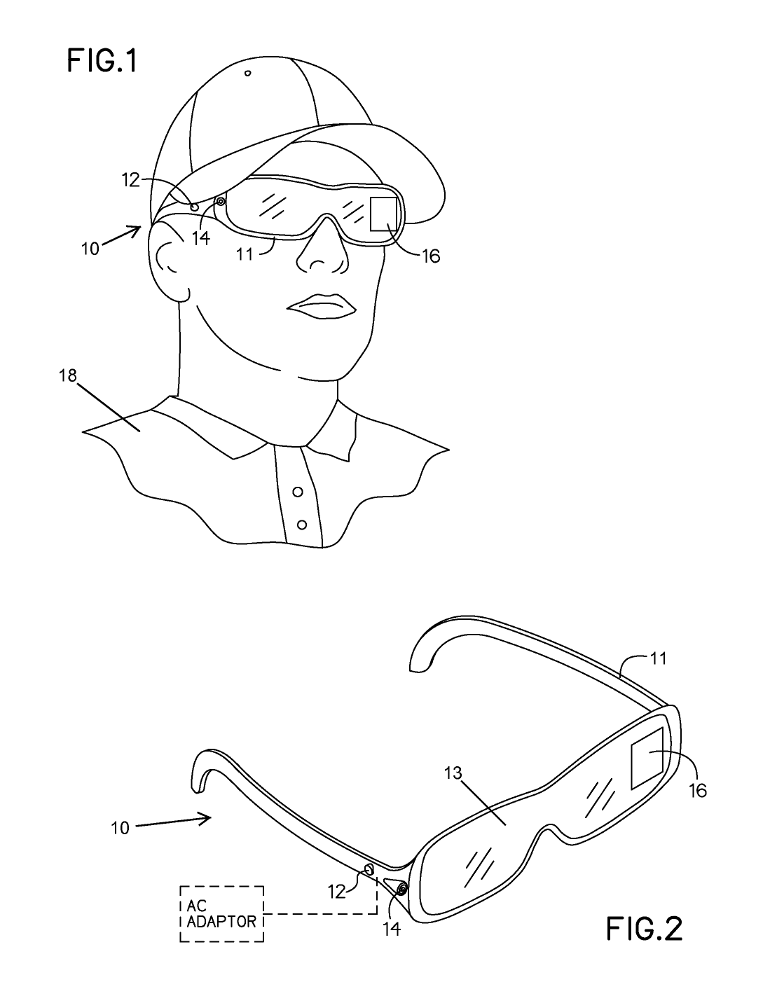

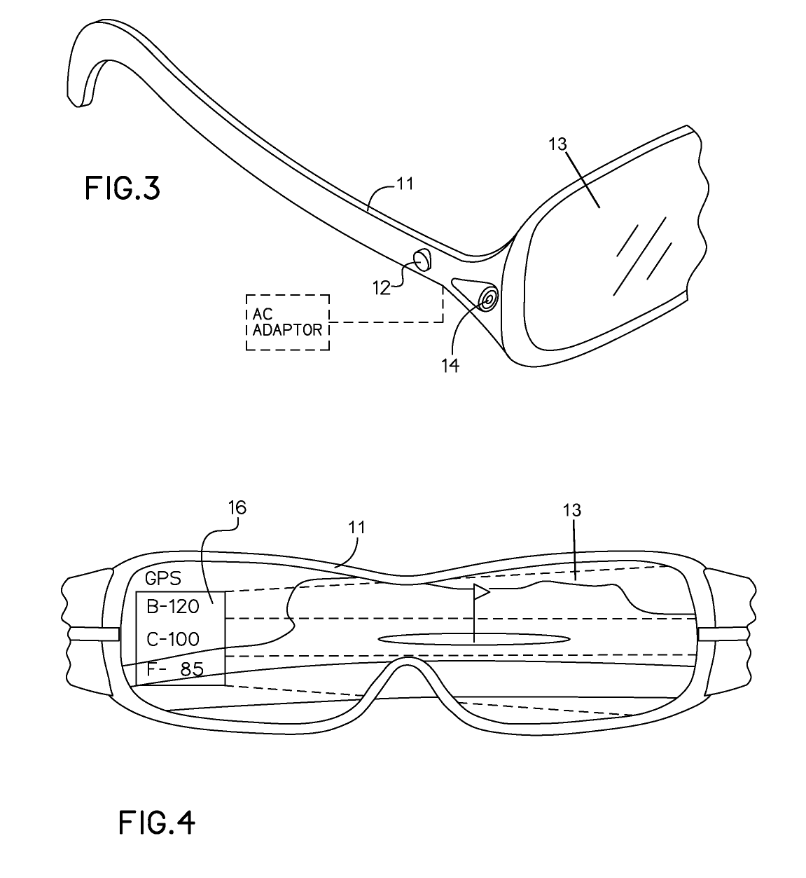

Referring to FIGS. 1 through 5, the present invention includes a pair of glasses 10. The pair of glasses 10 includes a glasses frame 11 that is formed to secure to a user's 18 head. The present invention may further include at least one lens 13, such as two lenses 13, attached to the glasses frame 10. The lens 13 includes an inner surface and an outer surface. The present invention further includes a lens display 16 projected on the inner surface of the lens 16. A laser rangefinder and a global positioning system are operatively connected to the lens display 16. Data from the laser rangefinder and the global positioning system is displayed on the lens display 16.

The glasses 10 of the present invention may be any type of glasses 10 and may include prescription lenses 13, sunglass lenses 13, clear lenses 13 and the like. The glasses 10 are provided in various styles and colors to accommodate user preference. The laser rangefinder and the global positioning system may be integrated into the glasses frame 11. A power cord may plug into a port on the side of the glasses 10 for charging. The present invention projects the determined distance onto the inner surface of the glasses 10 and protects and shields the eyes from the harsh sunlight.

As mentioned above, the present invention may include an integrated laser rangefinder. A laser rangefinder is a rangefinder which uses a laser beam to determine the distance to an object. The most common form of laser rangefinder operates on the time of flight principle by sending a laser pulse in a narrow beam towards the object and measuring the time taken by the pulse to be reflected off the target and returned to the sender. On the side of the sunglasses 10 may include a red laser pointer 14. As illustrated in FIG. 5, the user 18 may point the red laser 14 at sand traps, holes, the water, and other locations. The yardage to the selected area then projects onto the inner surface of the glasses 10 on the lens display 16. The device utilizes its laser feature to calculate user specific distances. This enables users 18 to better gauge what clubs to use, how to hit the ball, and at what angle. This increases accuracy for golfers when in use.

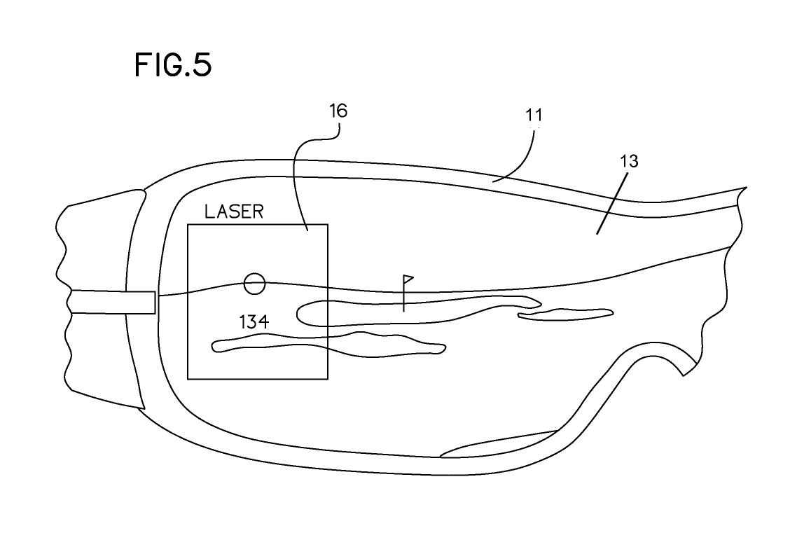

As mentioned above, the present invention may include an integrated GPS. The built in GPS may be used for determining the location of a user 18 on a golf course. This enables the device to notify the user 18 as to the distance to a hole. As illustrated in FIG. 4, the GPS functionality projects the distance to the back of any green (designated with a “B”), the distance to the center of the hole (designated with a “C”), and the distance to the front of the green (designated with an “F”) in a small square on the inner surface of the glasses 10 on the lens display 16.

The present invention may include at least one button 12. In certain embodiments, the present invention may include a plurality of buttons 12. The buttons 12 may include different functions. For example, the button 12 may be operable to turn the laser 14 of the laser rangefinder on and off. In certain embodiments, the button 12 may be operable to activate at least one of the laser range data and the global positioning system data to display on the lens display 16. In certain embodiments, by pressing the button 12 located on the side of the golf shade, the laser yardage may be brought up on the display lens 16 and the button 12 may be pressed again so that the GPS yardage on the lens may be brought up on the display lens 16.

It should be understood, of course, that the foregoing relates to exemplary embodiments of the invention and that modifications may be made without departing from the spirit and scope of the invention as set forth in the following claims.

What is claimed is:

1. A pair of glasses comprising:
a glasses frame formed to secure to a user's head;
at least one lens attached to the glasses frame, wherein the at least one lens comprises an inner surface and an outer surface;
a lens display projected on the inner surface of the lens;
a laser rangefinder operatively connected to the lens display;
a global positioning operatively connected to the lens display,
wherein data from the laser range and the global positioning system is displayed on the lens display.

2. The pair of glasses of claim 1, wherein the laser rangefinder and the global positioning system are integrated into the glasses frame.

3. The pair of glasses of claim 1, further comprising a button operable to turn a laser of the laser rangefinder on and off.

4. The pair of glasses of claim 1, further comprising a button operable to activate at least one of the laser range data and the global positioning system data to display on the lens display.

5. The pair of glasses of claim 1, wherein the at least one lens is a sunglass lens.
